(19) United States
(12) Patent Application Publication
(10) Pub. No.: US 2012/0105699 A1
(43) Pub. Date: May 3, 2012

(54) PORTABLE DEVICE

(76) Inventor: Shinya Takasumi, Tokyo (JP)

(21) Appl. No.: 13/005,339

(22) Filed: Jan. 12, 2011

(30) Foreign Application Priority Data
Jan. 13, 2010 (JP) 2010-005336

(51) Int. Cl. H04N 5/222; G03B 13/00; H04N 5/225

(52) U.S. Cl. 348/333.01; 348/207.99; 348/345; 348/E05.022

(57) ABSTRACT

A portable device includes an imaging unit that creates image data of a subject; a contrast detector that detects contrast information on the image data; a movement detector that detects movement information of the portable device; and a control unit that controls, in accordance with the contrast information when the movement information is detected, recording of the image data.

### CROSS-REFERENCE TO RELATED APPLICATION

This application is based upon and claims the benefit of priority from Japanese Patent Application No. 2010-005336, filed on Jan. 13, 2010, the entire contents of which are incorporated herein by reference.

### BACKGROUND OF THE INVENTION

1. Field of the Invention

The present invention relates to a portable device that creates image data of a subject.

2. Description of the Related Art

In recent years, for imaging devices used as portable devices, such as digital cameras or digital video cameras, there are known imaging devices that have an automatic capture function for automatically capturing an image if the subject image of image data to be captured meets a set imaging condition, such as a subject's face starts to smile (for example, see Japanese Laid-open Patent Publication No. 2009-71344 and Japanese Laid-open Patent Publication No. 2006-174105).

### SUMMARY OF THE INVENTION

A portable device according to an aspect of the present invention includes: an imaging unit that creates image data of a subject; a contrast detector that detects contrast information on the image data; a movement detector that detects movement information of the portable device; and a control unit that controls, in accordance with the contrast information obtained when the movement information is detected, recording of the image data.

A portable device according to another aspect of the present invention includes: an imaging unit that creates image data of a subject; a movement detector that detects movement of the portable device; and a control unit that controls, when the movement detector detects the movement, recording of the image data.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the configuration of an imaging device according to a first embodiment of the present invention;

FIG. 2 is a schematic diagram illustrating the configuration of a movement detector included in the imaging device according to the first embodiment of the present invention;

FIG. 3 is a schematic diagram illustrating the configuration of an acceleration sensor forming a part of the movement detector included in the imaging device according to the first embodiment of the present invention;

FIG. 4 is a schematic diagram illustrating a state in which a contrast detector included in the imaging device according to the first embodiment of the present invention detects the contrast of image data;

FIG. 5 is a schematic diagram illustrating the relation, under the condition illustrated in FIG. 4, between the capture distance from the imaging device according to the first embodiment of the present invention to the subject and the contrast of image data detected by the contrast detector;

FIG. 6 is a schematic diagram illustrating acceleration detected by an acceleration sensor forming a part of the movement detector;

FIG. 7 is a schematic diagram illustrating example images associated with image data of images captured by the imaging device according to the first embodiment of the present invention;

FIG. 8 is a flowchart illustrating the outline of a process performed by the imaging device according to the first embodiment of the present invention;

FIG. 9 is a flowchart illustrating the outline of an automatic capture mode performed by the imaging device according to the first embodiment of the present invention;

FIG. 10 is a flowchart illustrating the outline of a normal capture mode performed by the imaging device according to the first embodiment of the present invention;

FIG. 11 is a flowchart illustrating the outline of a play mode performed by the imaging device according to the first embodiment of the present invention;

FIG. 12 is a schematic diagram illustrating the relation between the capture distance from an imaging device according to a second embodiment of the present invention to a subject and the contrast of image data detected by the contrast detector;

FIG. 13 is a schematic diagram illustrating example images associated with image data of images captured by the imaging device according to the second embodiment of the present invention;

FIG. 14 is a flowchart illustrating the outline of an automatic capture mode performed by the imaging device according to the second embodiment of the present invention;

FIG. 15 is a schematic diagram illustrating the relation between the contrast of image data detected by the contrast detector and a focal point of a focus lens, on the optical axis, of the imaging unit;

FIG. 16 is a schematic diagram illustrating example images associated with image data of images captured by an imaging device according to a third embodiment of the present invention;

FIG. 17 is a flowchart illustrating the outline of an automatic capture mode performed by the imaging device according to the third embodiment of the present invention;

FIG. 18 is a schematic diagram illustrating an example of a display screen displayed by a display unit in the third embodiment of the present invention;

FIG. 19 is a schematic diagram illustrating an example of a display screen displayed by the display unit in the third embodiment of the present invention;

FIG. 20 is a schematic diagram illustrating an example of a display screen displayed by the display unit in the third embodiment of the present invention; and

FIG. 21 is a flowchart illustrating the outline of an automatic capture mode performed by an imaging device according to a fourth embodiment of the present invention.

### DETAILED DESCRIPTION OF THE PREFERRED EMBODIMENTS

In the following, preferred embodiments of an imaging device according to the present invention will be described in detail with reference to the accompanying drawings. However, the present invention is not limited to the embodiments. In the drawings, elements that are identical to those in embodiments are assigned the same reference numerals. In the following, a description will be given using an imaging device, such as a digital single-lens reflex camera, as an example of a portable device according to the present invention; however, the present invention is not limited to the embodiments.

### First Embodiment

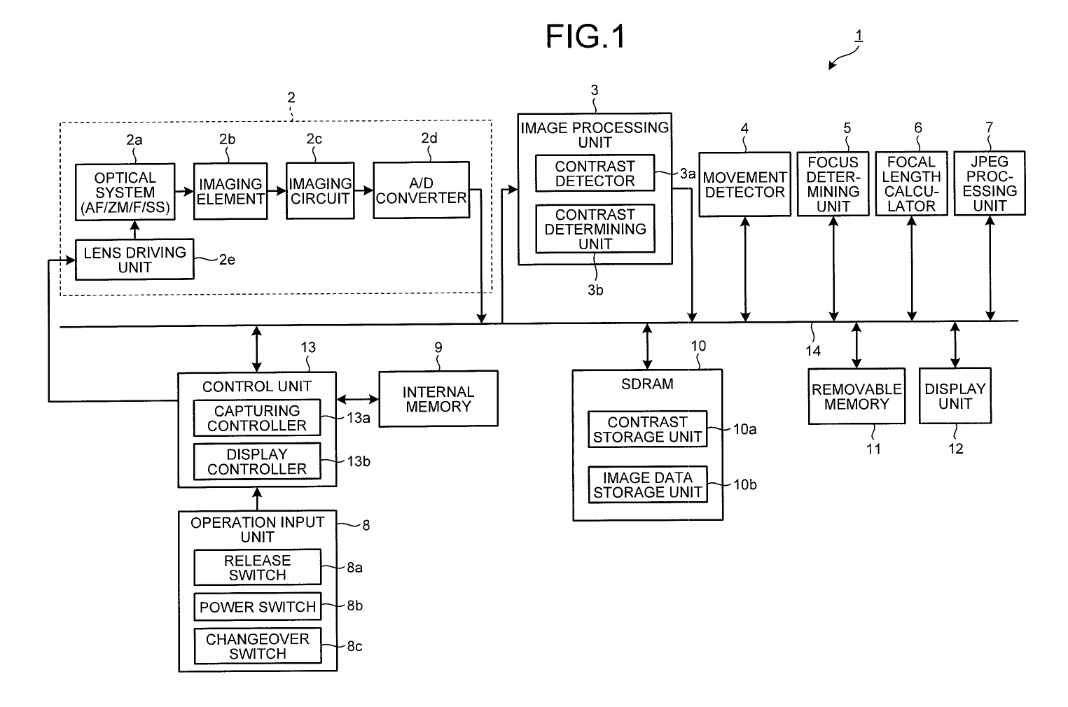

FIG. 1 is a block diagram illustrating the configuration of an imaging device according to a first embodiment of the present invention. As illustrated in FIG. 1, an imaging device 1 includes an imaging unit 2 that captures an area in the field of view and that creates electronic image data of the captured image; an image processing unit 3 that performs, on the image data created by the imaging unit 2, image processing, such as edge enhancement, color correction, and image compression; a movement detector 4 that detects the distance moved by the imaging device 1 every time the imaging device 1 moves; a focus determining unit 5 that determines a focal point of the imaging unit 2; a focal length calculator 6 that calculates the distance to the target focal point of the imaging unit 2; a JPEG processing unit 7 that performs, on the image data created by the imaging unit 2, a process of the Joint Photographic Experts Group (JPEG) compression method; an operation input unit 8 that receives inputs of various operation signals for the imaging device 1; an internal memory 9 that stores therein various kinds of information including various programs for operating the imaging device 1; a synchronous dynamic random access memory (SDRAM) 10 that temporarily stores therein various kinds of information including the image data created by the imaging unit 2 or the image data subjected to a process by the image processing unit 3; a removable memory 11 that stores therein various kinds of information including the image data subjected to a process by the JPEG processing unit 7; a display unit 12 that displays information including images corresponding to the image data subjected to a process by the image processing unit 3; a control unit 13 that controls the operation of the imaging device 1 in accordance with operation signals that are input by the operation input unit 8; and a bus line 14 that connects components of the imaging device 1.

The imaging unit 2 includes an optical system 2a that is formed by an auto focus (AF) lens, a zoom lens, a focus lens, and the like and that focuses light from a subject present in a predetermined area in the field of view; an aperture stop (not shown) that adjusts the amount of incident light that is focused by the optical system 2a; a shutter (not shown) that operates in accordance with a release input; an imaging element 2b, such as a complementary metal oxide semiconductor (CMOS) or a charge coupled device (CCD), that receives light passing through the aperture stop and the shutter and that converts the light to an electrical signal; an imaging circuit 2c that reduces reset noise from, for example, an electrical signal (analog image signal) being output from the imaging element 2b, performs waveform shaping, and increases gain so as to obtain a desired brightness; an A/D converter 2d that creates digital image data by converting, to a digital signal, the analog signal that is output from the imaging circuit 2c; and a lens driving unit 2e that drives various kinds of lenses in the optical system 2a and that changes the distance to the target focal point of the imaging unit 2 or changes a focal point of the imaging unit 2. The imaging unit 2 outputs the created image data via the bus line 14 to the SDRAM 10. Furthermore, in the imaging element 2b, Bayer-array color filters are arranged on the front surface of photodiodes forming each pixel. The Bayer array has, in the horizontal direction, a line on which an R pixel and a G (Gr) image are alternately arranged and a line on which a G (Gb) pixel and a B pixel are alternately arranged. Furthermore, these two lines are alternately arranged in the vertical direction.

The image processing unit 3 performs, on the image data read from the SDRAM 10, various kinds of image processing, such as an optical black subtraction process, a white balance correction process, a synchronization process, a gamma correction process, and a color reproduction process. The image processing unit 3 includes a contrast detector 3a that detects the contrast of the image data that is created as contrast information by the imaging unit 2 and a contrast determining unit 3b that determines the contrast of image data information detected by the contrast detector 3a. The contrast detector 3a detects the contrast of the image data created by the imaging unit 2 every time the imaging device 1 moves. Specifically, the contrast detector 3a detects the contrast of the image data created by the imaging unit 2 at intervals of a predetermined period ( 1/30 sec.) or every time the imaging device 1 moves. The contrast detector 3a outputs, to the SDRAM 10, the detected contrast of the image data via the bus line 14.

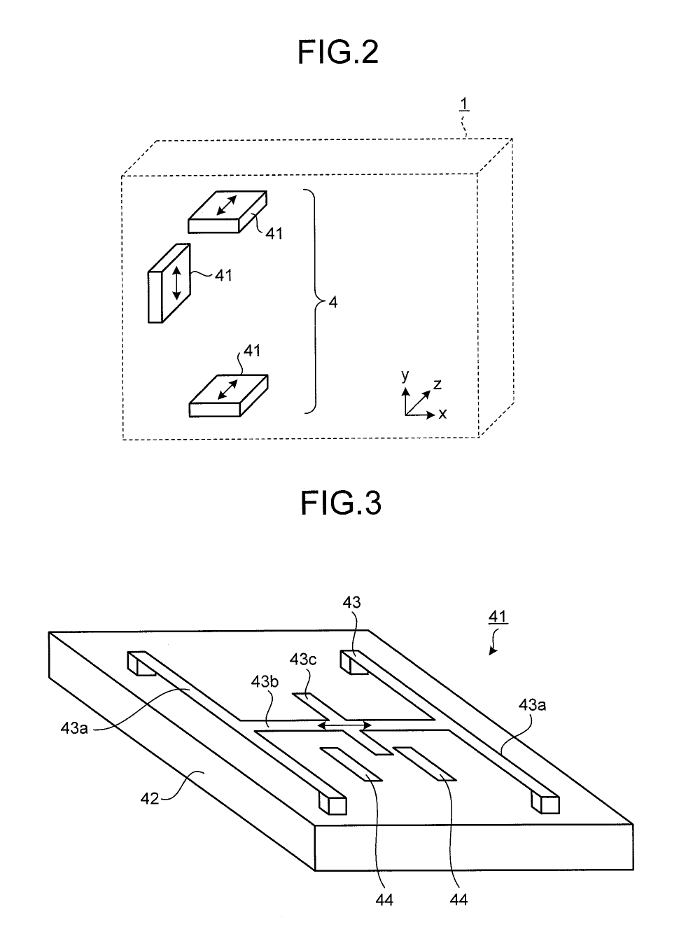

FIG. 2 is a schematic diagram illustrating the configuration of an acceleration detector forming a part of the movement detector 4. As illustrated in FIG. 2, the movement detector 4 includes three acceleration sensors 41 whose detection directions are orthogonal to each other. In the description below, it is assumed that the detection directions of the acceleration sensors 41, which are orthogonal to each other, are the x axis, the y axis, and the z axis. Furthermore, in FIG. 2, it is assumed that the proximal side is the front face side that faces a subject. FIG. 3 is a schematic diagram illustrating the configuration of the acceleration sensor 41. The acceleration sensor 41 illustrated in FIG. 3 is a capacitance-type acceleration sensor made by using a micro electro mechanical systems (MEMS) process. The acceleration sensor 41 includes a metal movable portion 43 that has a beam structure in which the ends of the movable portion 43 are secured near the four corners of the main surface of a cuboidal chip 42. The acceleration sensor 41 also includes two metal flat plate portions 44 that are arranged on the main surface of the chip 42, on which the ends of the movable portion 43 are secured. The movable portion 43 includes two extending portions 43a that extend, in a strip shape, in the same direction as the main surface of the chip 42 and whose ends are secured; a connecting portion 43b that connects, in the direction orthogonal to the extending direction of the extending portions 43a, a substantially central position of the two extending portions 43a; and a protrusion 43c that protrudes, in a strip shape from the central position of the connecting portion 43b, in the direction parallel to the extending direction of the extending portions 43a.

With the acceleration sensor 41 having such a configuration described above, if acceleration in the horizontal direction (arrow direction) in FIG. 3 increases, the movable portion 43, except for the ends of the extending portions 43a, is deformed by being bent in the horizontal direction; therefore, the positional relation between the protrusion 43c and the flat plate portions 44 varies, causing a change in capacitance. The acceleration sensor 41 outputs a signal (voltage) in accordance with this change in capacitance. In this way, the movement detector 4 detects, as movement information, the movement of the imaging device 1. The movement information detected by the movement detector 4 can be used for determining camera shake or when image correction is performed in accordance with this determination.

The focus determining unit 5 determines whether the imaging unit 2 is in a focal point in accordance with both the contrast of the image data detected by the contrast detector 3a and the peak value of the contrast of the image data stored in the SDRAM 10. If the imaging device 1 stops moving, the focal length calculator 6 calculates, in accordance with the movement information on the imaging device 1 detected by the movement detector 4, the distance to the target focal point of the imaging unit 2.

When the image data created by the imaging unit 2 is stored or when the stored image data is displayed, the JPEG processing unit 7 obtains the image data from the SDRAM 10 and performs a compression process or a decompression process on the image data in accordance with the JPEG compression method. The JPEG processing unit 7 stores the compressed JPEG image data in the SDRAM 10 or the removable memory 11.

The operation input unit 8 includes a release switch 8a that inputs a release signal; a power switch 8b that inputs a command signal such as a command for turning the power of the imaging device 1 on/off; and a changeover switch 8c that selects a various display modes or various operation modes displayed by the display unit 12. It is possible to configure the operation input unit 8 such that, by arranging a touch panel on the display unit 12 as a part of the operation input unit 8, a photographer can input an operation signal on the screen of the display unit 12.

The internal memory 9 is an electrically rewritable nonvolatile memory, such as a flash memory. The internal memory 9 stores therein various kinds of information including various programs for operating the imaging device 1. The internal memory 9 stores therein, for example, various parameters, such as white balance gain or a low-pass filter coefficient used in the image processing unit 3, that are necessary for the operation of the imaging device 1 or stores therein, for example, a serial number for identifying the imaging device 1.

The SDRAM 10 includes a contrast storage unit 10a that stores therein, in an associated manner, the peak value of the contrast of the image data created by the imaging unit 2 and the focal point of the imaging unit 2 and an image data storage unit 10b that stores therein the image data created by the imaging unit 2 or the image data that is subjected to a process by the image processing unit 3 or by the JPEG processing unit 7. The contrast storage unit 10a stores therein, in an associated manner, the distance moved by the imaging device 1 calculated by the movement detector 4 and the contrast of the image data detected by the contrast detector 3a.

The removable memory 11 is a removable memory card attached to/detached from the imaging device 1, such as an xD-picture card (registered trademark) or a compact flash (registered trademark). The removable memory 11 is connected to the bus line 14 via a memory I/F (not shown). The image data, which is subjected to a process by the image processing unit 3 or JPEG processing unit 7, is written to the removable memory 11 using a read/write device (not shown) or the image data stored in the removable memory 11 is read using the read/write device. It is possible to arrange the removable memory 11 integrally in the imaging device 1.

The display unit 12 is a display panel such as, a liquid crystal display, a plasma display, a liquid crystal display (LCD), or an organic EL (electroluminescence) display. The display unit 12 displays, in addition to an image and a live view image corresponding to image data or JPEG image data, operation information on the imaging device 1 or information related to the operation.

The control unit 13 is implemented by using, for example, a central processing unit (CPU), and is connected to each component in the imaging device 1 via the bus line 14. The control unit 13 includes a capturing controller 13a that controls the imaging operation of the imaging device 1 in accordance with an operation signal that is input by the operation input unit 8, the calculation result of the movement detector 4, the determination result of the focus determining unit 5, and the calculation result of the focal length calculator 6. The control unit 13 also includes a display controller 13b that controls a display mode of the image corresponding to the image data displayed by the display unit 12.

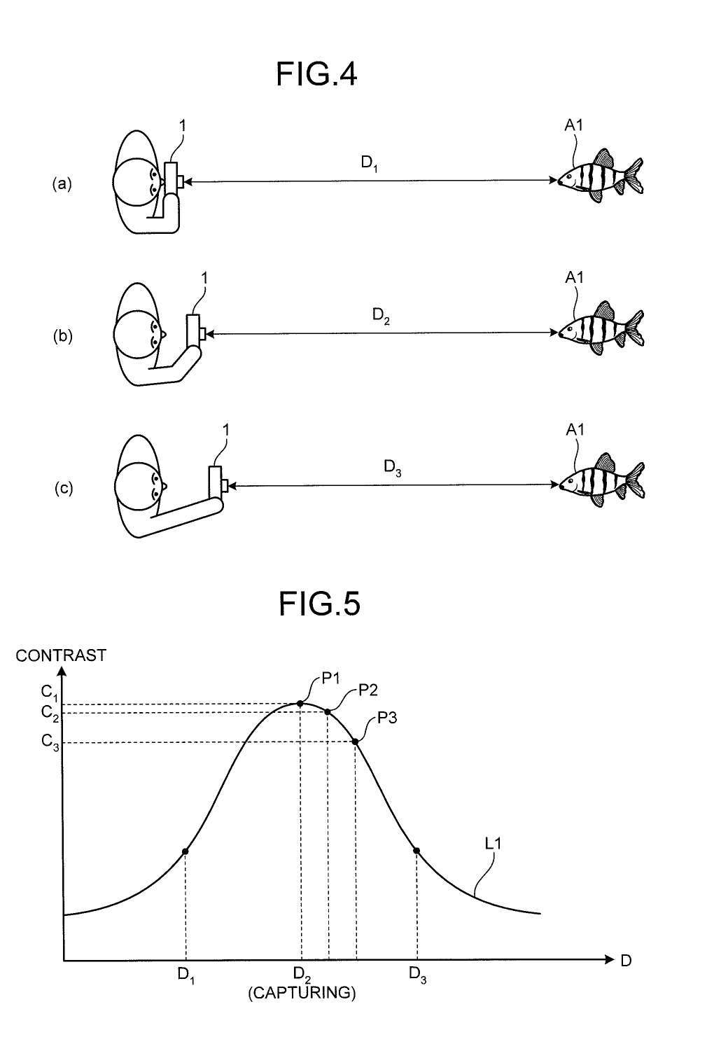

In the following, a state in which the contrast detector 3a detects the contrast of the image data created by the imaging unit 2 will be described. FIG. 4 is a schematic diagram illustrating a state in which the contrast detector 3a detects the contrast of the image data created by the imaging unit 2. Specifically, FIG. 4 illustrates a state in which, when a photographer captures, under water, a subject A1 using the imaging device 1, the contrast detector 3a detects the contrast of the image data created by the imaging unit 2. In the first embodiment of the present invention, the focus lens included in the optical system 2a does not move at a predetermined position on the optical axis of the imaging unit 2, for example, at the position on the side closest to the imaging unit 2.

In the state illustrated in FIG. 4, as a photographer brings the imaging device 1, in which the focal length of the imaging unit 2 is fixed, closer to the subject A1 (FIG. 4 (a) to FIG. 4 (c)), the contrast of the image data detected by the contrast detector 3a varies following the curve L1 illustrated in FIG. 5. In FIG. 5, the lateral axis indicates the capture distance between the imaging device 1 and the subject A1 and the vertical axis indicates the contrast.

As illustrated in FIG. 5, as a photographer brings the imaging device 1 closer to the subject A1, the contrast of the image data detected by the contrast detector 3a becomes a peak value C₁ (point P1) at the capture distance D₂ between the imaging device 1 and the subject A1. When the imaging unit 2 captures an image at point P1, it is possible to obtain in-focus image data with respect to the subject A1. Specifically, it is possible for the photographer to automatically obtain in-focus image data by simply bringing the imaging device 1 closer to the subject A1 while maintaining the state in which the focus lens of the optical system 2a is fixed on the optical axis of the imaging unit 2 and by capturing an image at the focal point of the imaging unit 2 where the contrast of the image data becomes a peak value.

In the first embodiment of the present invention, the contrast storage unit 10a stores therein, in an associated manner, the peak value of the contrast of the image data created by the imaging unit 2 and the focal point of the imaging unit 2. Accordingly, the focus determining unit 5 determines whether the imaging unit 2 is at the focal point in accordance with both the contrast of the image data detected by the contrast detector 3a and the peak value of the contrast of the image data stored in the contrast storage unit 10a. If the result of the determination performed by the focus determining unit 5 is that the imaging unit 2 is at the focal point, the capturing controller 13a controls the storing of the image data created by the imaging unit 2 in such a manner that it is stored in the removable memory 11. Furthermore, the capturing controller 13a detects, every time the imaging device 1 moves, the contrast of the image data detected by the contrast detector 3a. If the contrast of the image data continuously decreases, the capturing controller 13a determines, as the peak value of the contrast of the image data, the position immediately before the contrast of the image data starts dropping. Specifically, in FIG. 5, if the contrast continuously decreases through a point P2 (contrast C2) and a point P3 (contrast C3) where the contrast detector 3a detects the contrast following the detecting of the point P1, the capturing controller 13a determines the point P1 as the peak value of the contrast of the image data.

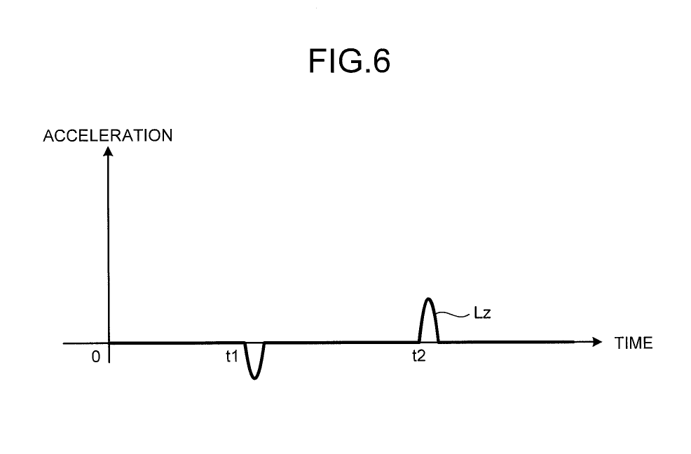

FIG. 6 is a schematic diagram illustrating the temporal variation in the acceleration detected, when a photographer moves the imaging device 1 toward the subject A1 under the condition illustrated in FIG. 4, by the acceleration sensors 41 forming a part of the movement detector 4. In FIG. 6, a curve Lz indicates the temporal variation in the acceleration in the z-axis direction of the imaging device 1 (see FIG. 2). In FIG. 6, the lateral axis indicates the time and the vertical axis indicates the acceleration detected by the acceleration sensors 41. Furthermore, in FIG. 6, the acceleration in the z-axis direction is positive.

As illustrated in FIG. 6, a state is illustrated in which a photographer starts moving the imaging device 1 toward the subject A1 at the time t1 (FIG. 4 (a)), the photographer moves the imaging device 1 at a constant speed, and then the photographer stops at a time t2 (FIG. 4 (c)). Using the detection result of the acceleration sensors 41, the movement detector 4 detects, as movement information on the imaging device 1, the distance moved between the time t1 and the time t2. Because the components of the acceleration in the x-axis direction and the y-axis direction vary at the same time, it is possible to calculate the distance moved by the imaging device 1 by taking into consideration the components of the acceleration in the x-axis direction and the y-axis direction.

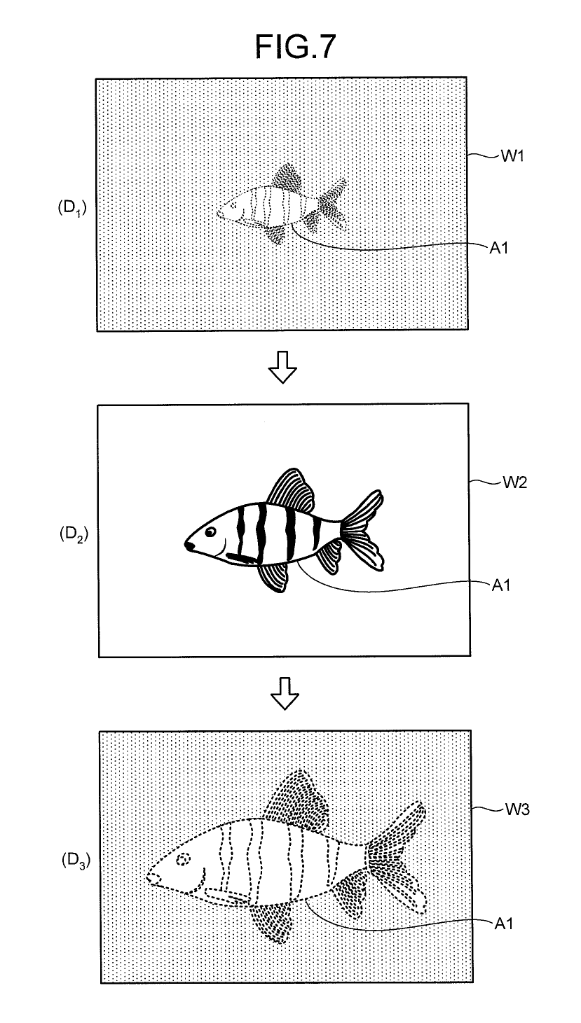

FIG. 7 is a schematic diagram illustrating example images, under the condition illustrated in FIG. 4, corresponding to image data captured by the imaging device 1. An image W1 indicates an image that corresponds to the image data created at a capture distance D₁ that is closer to the capture distance corresponding to the peak value of the contrast of the imaging unit 2; an image W2 indicates an image that corresponds to the image data created at a capture distance D₂ corresponding to the peak value of the contrast of the imaging unit 2; and an image W3 indicates an image that corresponds to the image data created at a capture distance D₃ away from the capture distance corresponding to the peak value of the contrast of the imaging unit 2. As illustrated in FIG. 7, by capturing an image at the capture distance D₂ that corresponds to the peak value of the contrast, the imaging device 1 can obtain desired image data, i.e., an in-focus image W2. In contrast, because the contrast is low at the capture distances D₁ and D₃ that are away from the peak value of the contrast, the images W1 and W3 are out of focus.

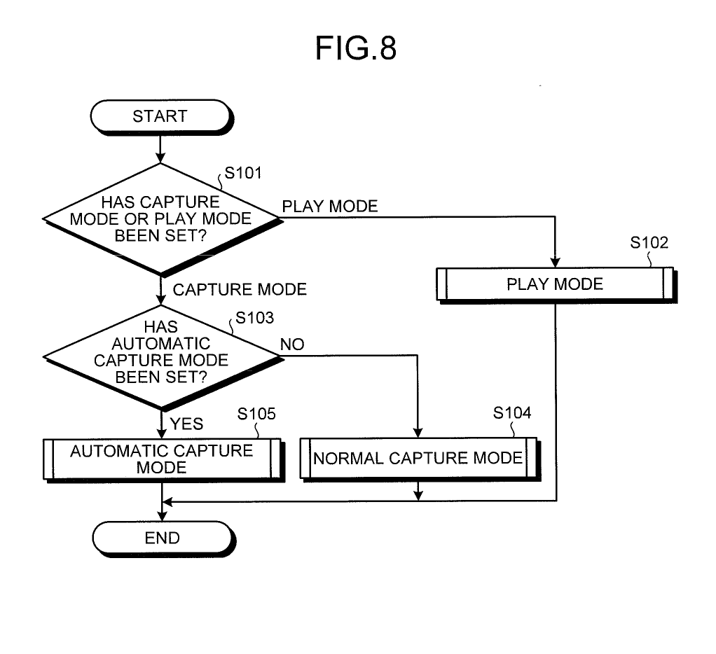

FIG. 8 is a flowchart illustrating the outline of a process performed by the imaging device 1 according to the first embodiment of the present invention. In FIG. 8, the capturing controller 13a determines whether a capture mode or a play mode is set (Step S101). If the play mode is set (play mode at Step S101), the imaging device 1 performs in the play mode (Step S102) and ends the process. In contrast, if a capture mode is set (capture mode at Step S101), the imaging device 1 proceeds to Step S103.

Then, the capturing controller 13a determines whether an automatic capture mode is set (Step S103). Specifically, the capturing controller 13a determines whether the automatic capture mode is set by the changeover switch 8c. If the automatic capture mode is not set (No at Step S103), the imaging device 1 performs in the normal capture mode (Step S104) and ends the process. In contrast, if the automatic capture mode is set (Yes at Step S103), the imaging device 1 performs in the automatic capture mode (Step S105) and ends the process.

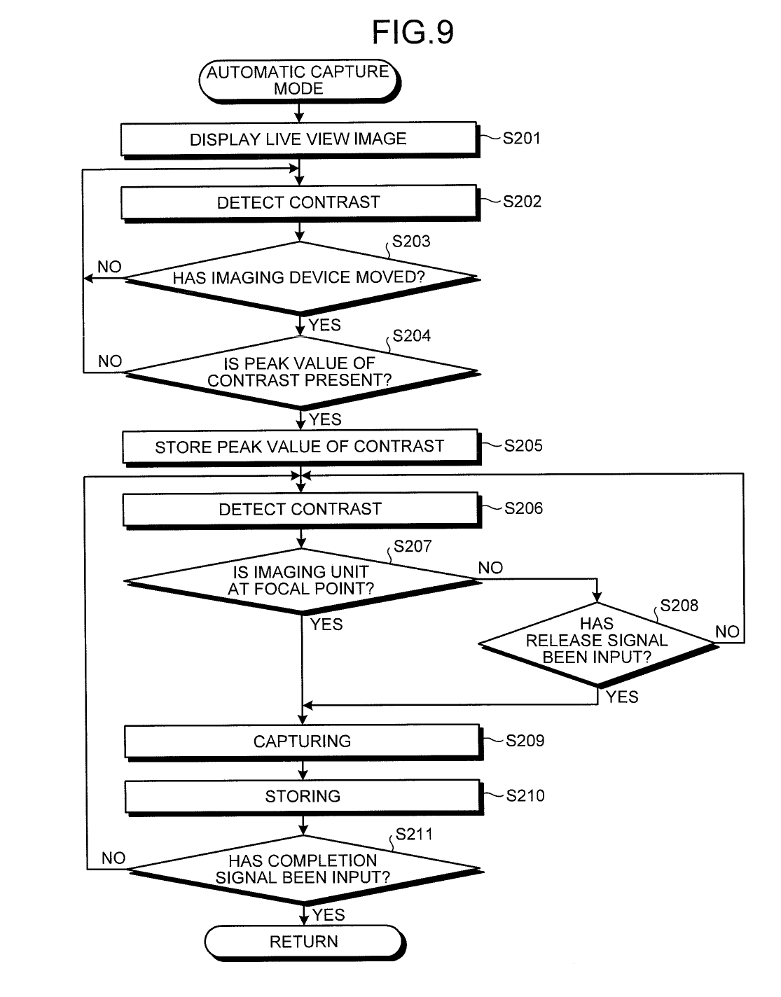

The automatic capture mode performed by the imaging device 1 will be described with reference to the flowchart illustrated in FIG. 9. In FIG. 9, the display unit 12 displays a live view image corresponding to the image data created by the imaging unit 2 (Step S201).

Then, the contrast detector 3a detects the contrast of the image data created by the imaging unit 2 (Step S202).

Subsequently, the capturing controller 13a determines whether the imaging device 1 has moved (Step S203). Specifically, the capturing controller 13a determines the movement of the imaging device 1 by detecting the variation in an output voltage of the acceleration sensors 41 forming a part of the movement detector 4. If the imaging device 1 has not moved (No at Step S203), the imaging device 1 proceeds to Step S202. In contrast, if the imaging device 1 has moved (Yes at Step S203), the imaging device 1 proceeds to Step S204.

Then, the capturing controller 13a determines whether a peak value is present in the contrast of a plurality of pieces of image data detected by the contrast detector 3a (Step S204). If a peak value is not present in the contrast of the plurality of pieces of image data (No at Step S204), the imaging device 1 proceeds to Step S202. In contrast, if a peak value is present in the contrast of the plurality of pieces of image data (Yes at Step S204), the contrast storage unit 10a stores therein, in an associated manner, the movement information on the imaging device 1 detected by the movement detector 4 and the peak value of the contrast detected by the contrast detector 3a (Step S205).

Subsequently, the contrast detector 3a detects the contrast of the image data created by the imaging unit 2 (Step S206).

Thereafter, the focus determining unit 5 determines, in accordance with both the contrast of the image data detected by the contrast detector 3a and the peak value of the contrast of the image data stored in the contrast storage unit 10a, whether the imaging unit 2 is at the focal point (Step S207). If the imaging unit 2 is not at the focal point (No at Step S207), the capturing controller 13a determines whether a release signal has been input by an operation of the release switch 8a (Step S208). If the release signal has not been input (No at Step S208), the imaging device 1 proceeds to Step S206. In contrast, if the release signal has been input (Yes at Step S208), the imaging device 1 proceeds to Step S209.

In contrast, if the imaging unit 2 is at the focal point (Yes at Step S207), the imaging device 1 performs, under the control of the capturing controller 13a, a capturing control in which image data is recorded (Step S209).

Subsequently, the capturing controller 13a allows the removable memory 11 to store the image data that is created by the imaging unit 2 and that is subjected to the image processing by the image processing unit 3 (Step S210).

Then, the capturing controller 13a determines whether a completion signal indicating the completion of the imaging has been input (Step S211). If the completion signal has not been input (No at Step S211), the imaging device 1 proceeds to Step S206. In contrast, if the completion signal has been input (Yes at Step S211), the imaging device 1 returns to the main routine.

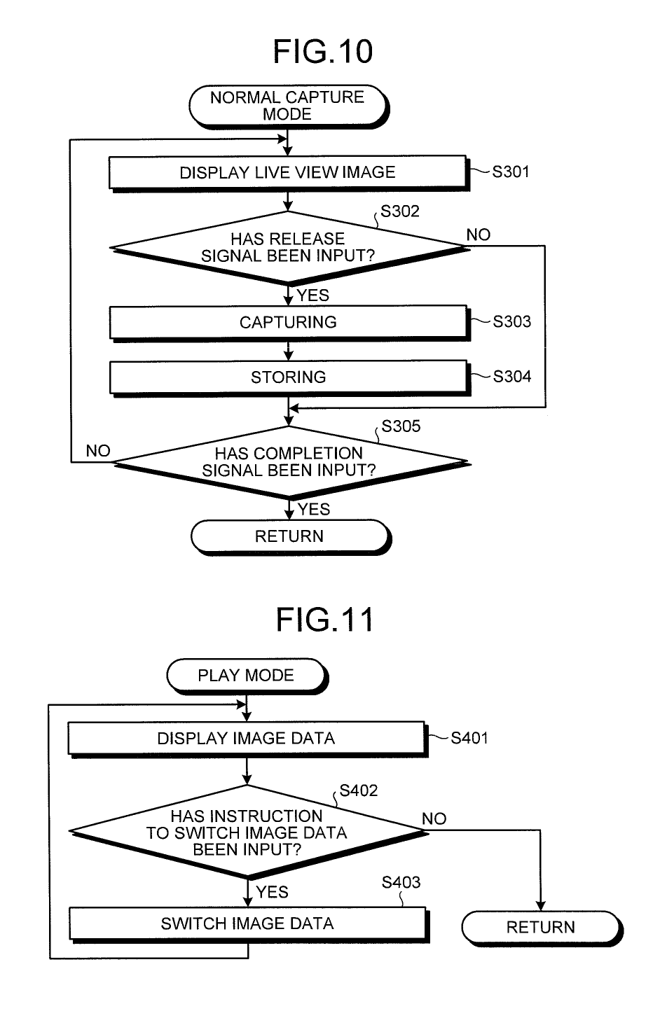

In the following, the normal capture mode in which the imaging device 1 performs will be described with reference to the flowchart illustrated in FIG. 10. In FIG. 10, the display unit 12 displays an image (live view image) corresponding to the image data created by the imaging unit 2 (Step S301).

Then, the capturing controller 13a determines whether a release signal has been input by an operation of the release switch 8a (Step S302). If the release signal has not been input (No at Step S302), the imaging device 1 proceeds to Step S305. In contrast, if the release signal has been input (Yes at Step S302), the imaging device 1 performs, under the control of the capturing controller 13a, the capturing so as to record image data (Step S303).

Subsequently, the capturing controller 13a allows the removable memory 11 to store the image data that is created by the imaging unit 2 and that is subjected to the image processing by the image processing unit 3 (Step S304).

Then, the capturing controller 13a determines whether a completion signal indicating the completion of the imaging has been input (Step S305). If the completion signal has not been input (No at Step S305), the imaging device 1 returns to Step S301 and repeats the processes at Steps S301 to S304. In contrast, if the completion signal has been input (Yes at Step S305), the imaging device 1 returns to the main routine.

In the following, the play mode in which the imaging device 1 performs will be described with reference to the flowchart illustrated in FIG. 11. In FIG. 11, the display unit 12 displays image data from among the image data stored in the image data storage unit 10b or in the removable memory 11 (Step S401).

Then, the display controller 13b determines whether a changeover signal that switches the image data displayed by the display unit 12 has been input by the changeover switch 8c (Step S402). If the changeover signal has not been input (No at Step S402), the imaging device 1 returns to the main routine. In contrast, if the changeover signal has been input (Yes at Step S402), the display unit 12 switches image data to be displayed (Step S403) and proceeds to Step S401.

According to the first embodiment of the present invention described above, in accordance with the contrast of the image data, which is detected by the contrast detector 3a, and a peak value of the contrast of the image data, which is created by the imaging unit 2 and is stored in the contrast storage unit 10a, the focus determining unit 5 determines whether the imaging unit 2 is at a focal point. If the result determined by the focus determining unit 5 is that the imaging unit 2 is at the focal point, the capturing controller 13a controls the recording of the image data. Accordingly, even if the capturing is performed under water where visibility is poor or a capturing operation is awkward, it is possible to easily perform the capturing in good focus. Furthermore, because contrast information that is obtained in advance is used, it is possible to reliably obtain image data of the subject A1. Furthermore, because the contrast storage unit 10a stores therein, in an associated manner, a previously fixed focal length of the imaging unit 2 and a focal point of the imaging unit 2 corresponding to the peak value of the contrast of the image data, the contrast detector 3a is required to detect the contrast of the image data only once and a photographer can perform automatic capturing without having to worry about the focal point of the imaging unit 2. Furthermore, the photographer can perform the automatic capturing by simply bringing the imaging device 1 closer to or farther away from the subject A1.

### Second Embodiment

In the following, a second embodiment of the present invention will be described. In the first embodiment described above, by fixing the focus lens included in the optical system 2a at a predetermined position on the optical axis of the imaging unit 2, the distance to the target focal point of the imaging unit 2 is fixed. However, in the second embodiment of the present invention, the distance to the target focal point of the imaging unit 2 is changed in accordance with the capture distance between the imaging device 1 and the subject A1. Furthermore, in the second embodiment, before the focus determining unit 5 changes the distance to the target focal point of the imaging unit 2 stored in the contrast storage unit 10a, a focal point of the imaging unit 2, which is obtained after the changing of the distance to the target focal point of the imaging unit 2, is determined by using a peak value of the image data that corresponds to the focal point of the imaging unit 2 detected by the contrast detector 3a.

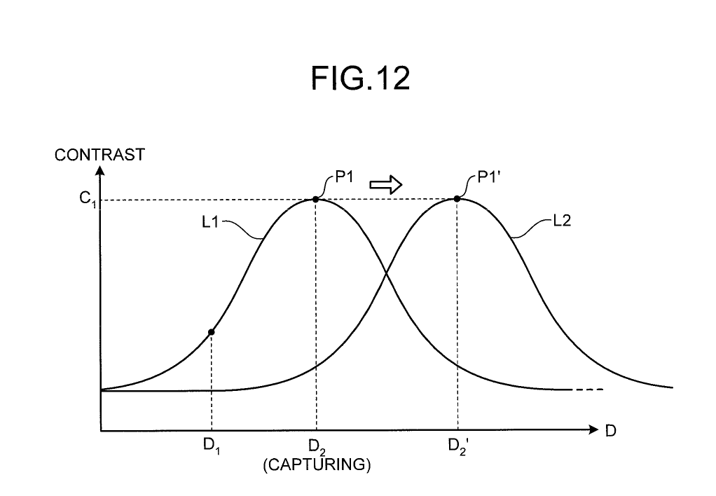

FIG. 12 is a schematic diagram illustrating the relation between the capture distance from the imaging device 1 to the subject A1 and the contrast of the image data detected by the contrast detector 3a. The curve L1 illustrated in FIG. 12 indicates the contrast of the image data detected, by the contrast detector 3a, after the focal point of the imaging unit 2 has been changed and the curve L2 indicates the contrast of the image data detected, by the contrast detector 3a, before a focus adjustment position of the imaging unit 2 has been changed. In FIG. 12, the lateral axis indicates the capture distance between the imaging device 1 and the subject A1 and the vertical axis indicates the contrast. The point P1 indicates a focal point of the imaging unit 2 obtained after the focal point of the imaging unit 2 has been changed. The point P1′ indicates a focal point of the imaging unit 2 before the focal point of the imaging unit 2 has been changed.

As illustrated in FIG. 12, the capturing controller 13a drives, in accordance with the calculation result determined by the focal length calculator 6, the lens driving unit 2e and moves, by moving the focus lens of the optical system 2a, the capture distance between the imaging device 1 and the subject A1 from, for example, the capture distance D₂′ to the capture distance D₂. Then, the focus determining unit 5 determines, in accordance with the contrast of the image data, which is detected by the contrast detector 3a and the peak value of the image data, which is created by the imaging unit 2 and is stored in the contrast storage unit 10a, whether the position is the focal point of the imaging unit 2. If the result determined by the focus determining unit 5 is the focal point of the imaging unit 2, the capturing controller 13a controls the recording of the image data created by the imaging unit 2. Accordingly, even if the capture distance between the imaging device 1 and the subject A1 varies every time the imaging device 1 moves, it is not necessary to detect, each time with respect to the same subject A1, the peak value of the contrast of the image data that corresponds to the focal point of the imaging unit 2 and it is possible to capture the subject A1 by selecting again the peak value of the contrast of the image data that corresponds to the focal point of the imaging unit 2. Furthermore, it is possible to capture the subject A1 by simply bringing the imaging device 1 closer to the subject and changing the distance to the target focal point of the imaging unit 2. Specifically, the contrast reaches its peak when a camera is located at the capture distance D₂′ between the subject and the imaging device 1. Because the camera is further brought closer to the subject, the distance to the subject is brought closer to the capture distance D₂′; however, it is possible to implement a good focus and prompt imaging by correcting the shifting of the focal point in proportion to the distance the imaging device 1 is closer to the subject.

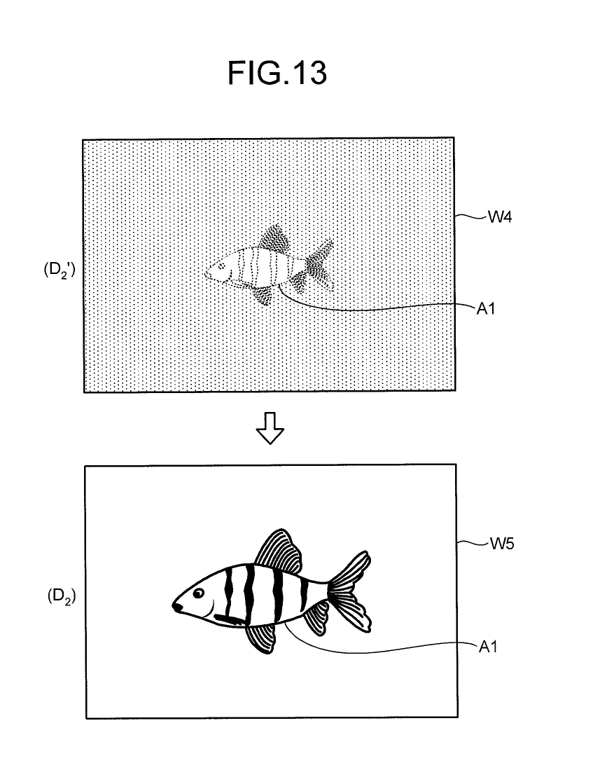

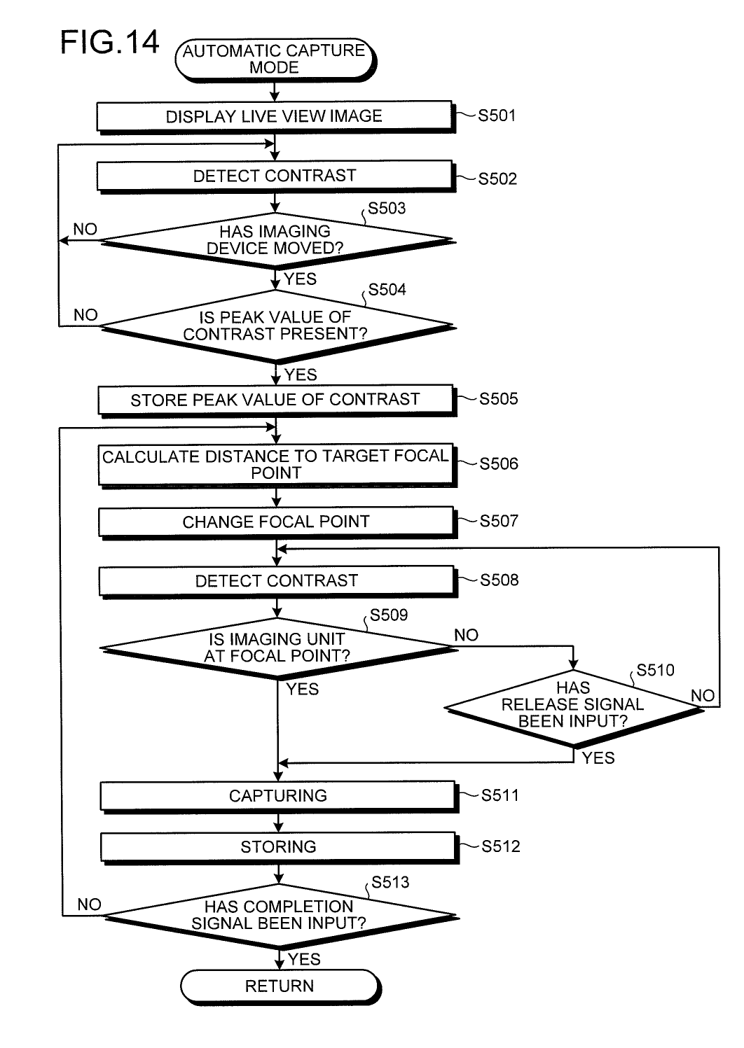

FIG. 13 is a schematic diagram illustrating example images corresponding to image data of images captured by the imaging device 1 when the distance to the target focal point of the imaging unit 2 is changed. An image W4 indicates an image corresponding to the image data created, by the imaging unit 2, at a capture distance D₂′ after the distance to the target focal point of the imaging unit 2 has been changed. An image W5 indicates an image corresponding to the image data created, by the imaging unit 2, at a capture distance D₂ after the distance to the target focal point of the imaging unit 2 has been changed. As illustrated in FIG. 13, even when the distance to the focal point of the imaging unit 2 is changed due to the capturing controller 13a driving the lens driving unit 2e so that it moves the focus lens of the optical system 2a and changes the distance to the target focal point of the imaging unit 2, the contrast detector 3a does not need to detect again a peak value of the contrast of the image data; therefore, it is possible to obtain an image corresponding to in-focus image data.

FIG. 14 is a flowchart illustrating, in detail, the flow of the process performed by the imaging device 1 according to the second embodiment of the present invention when it is in the automatic capture mode. In FIG. 14, the display unit 12 displays a live view image corresponding to the image data created by the imaging unit 2 (Step S501).

Then, the contrast detector 3a detects the contrast of the image data created by the imaging unit 2 (Step S502).

Subsequently, the capturing controller 13a determines whether the imaging device 1 has moved (Step S503). If the imaging device 1 has not moved (No at Step S503), the imaging device 1 proceeds to Step S502. In contrast, if the imaging device 1 has moved (Yes at Step S503), the imaging device 1 proceeds to Step S504.

Then, the capturing controller 13a determines whether a peak value of the contrast is present in the contrast of a plurality of pieces of image data detected by the contrast detector 3a (Step S504). If a peak value is not present in the contrast of the plurality of pieces of image data (No at Step S504), the imaging device 1 proceeds to Step S502. In contrast, if a peak value is present in the contrast of the plurality of pieces of image data (Yes at Step S504), the imaging device 1 proceeds to Step S505.

Subsequently, the contrast storage unit 10a stores therein, in an associated manner, the distance moved by the imaging device 1 calculated by the movement detector 4 and the peak value of the contrast of the image data detected by the contrast detector 3a (Step S505).

Thereafter, the focal length calculator 6 (focus distance calculator) calculates, in accordance with the movement of the imaging device 1 calculated by the movement detector 4, the distance to the target focal point of the imaging unit 2 (Step S506).

Subsequently, by driving the lens driving unit 2e so that it is brought closer to the distance to the target focal point calculated by the focal length calculator 6 and by moving the focus lens in the optical system 2a, the capturing controller 13a changes the focal point of the imaging unit 2 (Step S507).

Then, the contrast detector 3a detects the contrast of the image data created by the imaging unit 2 (Step S508).

Subsequently, the focus determining unit 5 determines, in accordance with the contrast of the image data detected by the contrast detector 3a, whether the imaging unit 2 is at the focal point (Step S509). If the imaging unit 2 is not at the focal point (No at Step S509), the capturing controller 13a determines whether a release signal has been input by an operation of the release switch 8a (Step S510). If the release signal has not been input (No at Step S510), the imaging device 1 proceeds to Step S508. In contrast, if the release signal has been input (Yes at Step S510), the imaging device 1 proceeds to Step S511.

In contrast, if the focus determining unit 5 determines that the imaging unit 2 is at the focal point (Yes at Step S509), the imaging device 1 performs, under the control of the capturing controller 13a, the capturing to record image data (Step S511). When using an automatic capture mode in which a camera is brought closer to a subject, it is not necessary to strictly calculate the distance; specifically, by moving an in-focus lens so as to focus on a short distance, an image can be captured when the contrast is brought closer to the point P1′.

Subsequently, the capturing controller 13a allows the removable memory 11 to store the image data of the image that is created by the imaging unit 2 and that is subjected to image processing by the image processing unit 3 (Step S512).

Then, the capturing controller 13a determines whether a completion signal indicating the completion of the capturing has been input (Step S513). If the completion signal has not been input (No at Step S513), the imaging device 1 proceeds to Step S506. In contrast, if the completion signal has been input (Yes at Step S513), the imaging device 1 returns to the main routine.

According to the second embodiment of the present invention described above, a focal length of the imaging unit 2 can be changed in accordance with the movement of the imaging device 1. Accordingly, even when the focal length of the imaging unit 2 is changed in accordance with the movement of the imaging device 1, there is no need to detect again the peak value of the contrast with respect to the same subject A1. Furthermore, simply by bringing the imaging device 1 closer to the subject A1 so as to change the distance to the target focal point of the imaging unit 2, it is possible to capture the subject A1 and obtain in-focus image data. Furthermore, because there is no need to detect the peak value of the contrast of the image data every time the imaging device 1 moves, continuous capturing is possible in a short period of time. The contrast is obtained by digitizing the difference between brightness and darkness at the central part of the captured data or digitizing the output difference between the neighboring pixels. It is assumed that the sharper the image, the greater the value that is output.

### Third Embodiment

In the following, a third embodiment of the present invention will be described. In the first and second embodiments, the peak value of the contrast of the image data is manually detected by a photographer moving the imaging device 1; however, in the third embodiment of the present invention, the peak value of the contrast of the image data is automatically detected by moving the focus lens included in the optical system 2a along the optical axis of the imaging unit 2.

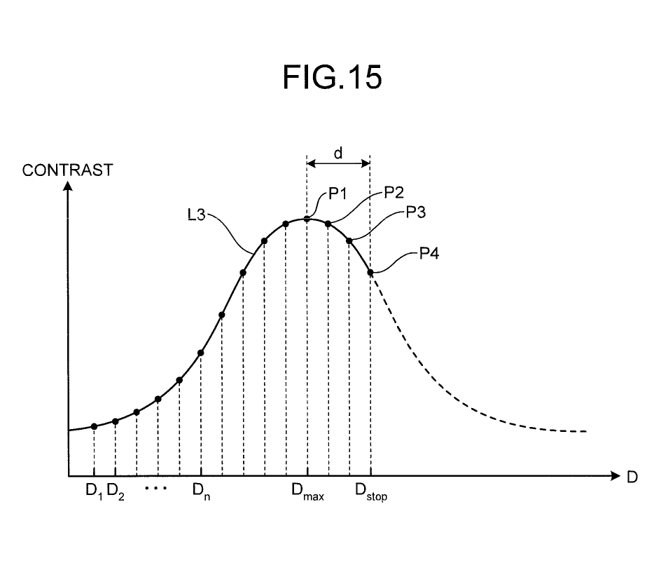

FIG. 15 is a schematic diagram illustrating the relation between the contrast of the image data detected by the contrast detector 3a and focal points of a focus lens, on the optical axis, of the imaging unit 2. A curve L3 illustrated in FIG. 15 indicates the contrast of the image data corresponding to the focal points, on the optical axis of the imaging unit 2, of the focus lens in the optical system 2a. In FIG. 15, the lateral axis indicates a focal point of the focus lens on the optical axis of the imaging unit 2 and the vertical axis indicates the contrast. A point P1 indicates the peak value of the contrast of the image data corresponding to the focal point. Each of the points P2, P3, and P4 indicates the contrast of the image data obtained when a focal point of the focus lens moves by a predetermined distance from the peak value of the contrast of the image data corresponding to the focal point. In the third embodiment of the present invention, when the contrast of the image data is to be detected, the distance between the subject A1 and the imaging unit 2 are kept constant and the zoom lens included in the optical system 2a is fixed on the optical axis of the imaging unit 2. Contrast information is information obtained for each scanning position of the focal scanning.

As illustrated in FIG. 15, because the lens driving unit 2e moves the focus lens along the optical axis of the imaging unit 2, the contrast of the image data detected by the contrast detector 3a varies. Accordingly, the capturing controller 13a compares, every time the focus lens moves, the contrast of the image data detected by the contrast detector 3a. If the contrast of the image data continuously decreases, the capturing controller 13a detects, as the peak value of the contrast of the image data, the position immediately before the contrast of the image data starts dropping. Specifically, in FIG. 15, if the contrast of the image data is continuously decreases through the points P2 to P4, the point P1 is detected as the peak value of the contrast of the image data. Furthermore, if a peak value of the contrast of the image data is detected, the capturing controller 13a drives the lens driving unit 2e to stop the movement of the focus lens. Specifically, by driving the lens driving unit 2e, the capturing controller 13a stops the focus lens at a focal point Dₛₜₒₚ corresponding to the point P4. Furthermore, by driving the lens driving unit 2e, the capturing controller 13a moves the focus lens to the focal point Dₘₐₓ (movement distance d) and allows the imaging unit 2 to capture an image.

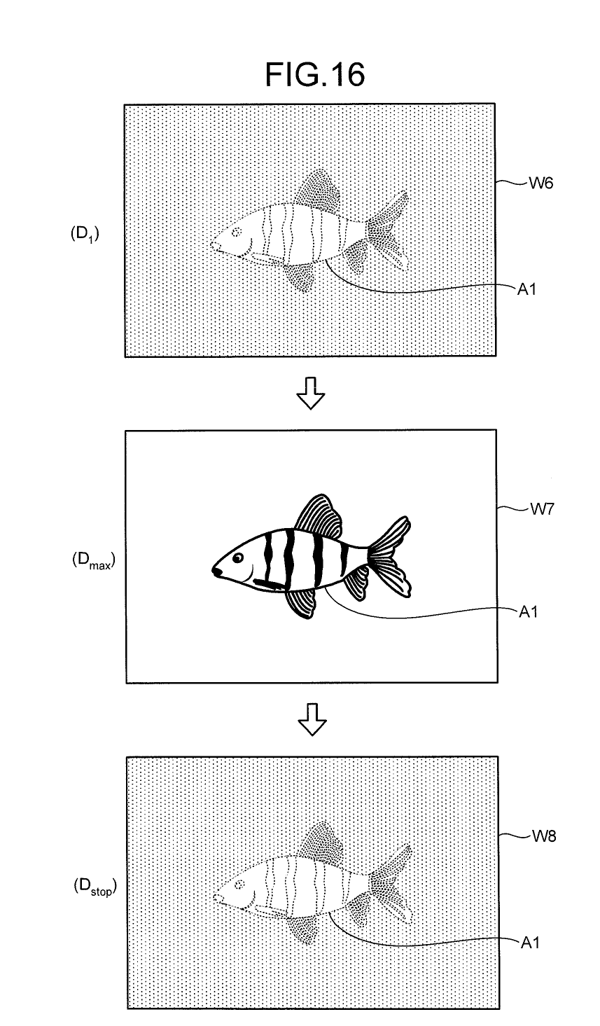

FIG. 16 is a schematic diagram illustrating example images associated with image data of images captured by the imaging device 1. An image W6 indicates an image corresponding to the image data created, by the imaging unit 2, at the focal point D₁ of the focus lens; an image W7 indicates an image corresponding to the image data created, by the imaging unit 2, at the focal point Dₘₐₓ of the focus lens; and an image W8 indicates an image corresponding to the image data created, by the imaging unit 2, at the focal point Dₛₜₒₚ of the focus lens. As illustrated in FIG. 16, because the imaging unit 2 captures an image at the focal point Dₘₐₓ of the focus lens corresponding to the peak value of the contrast, it is possible to obtain the image W7 corresponding to in-focus image data.

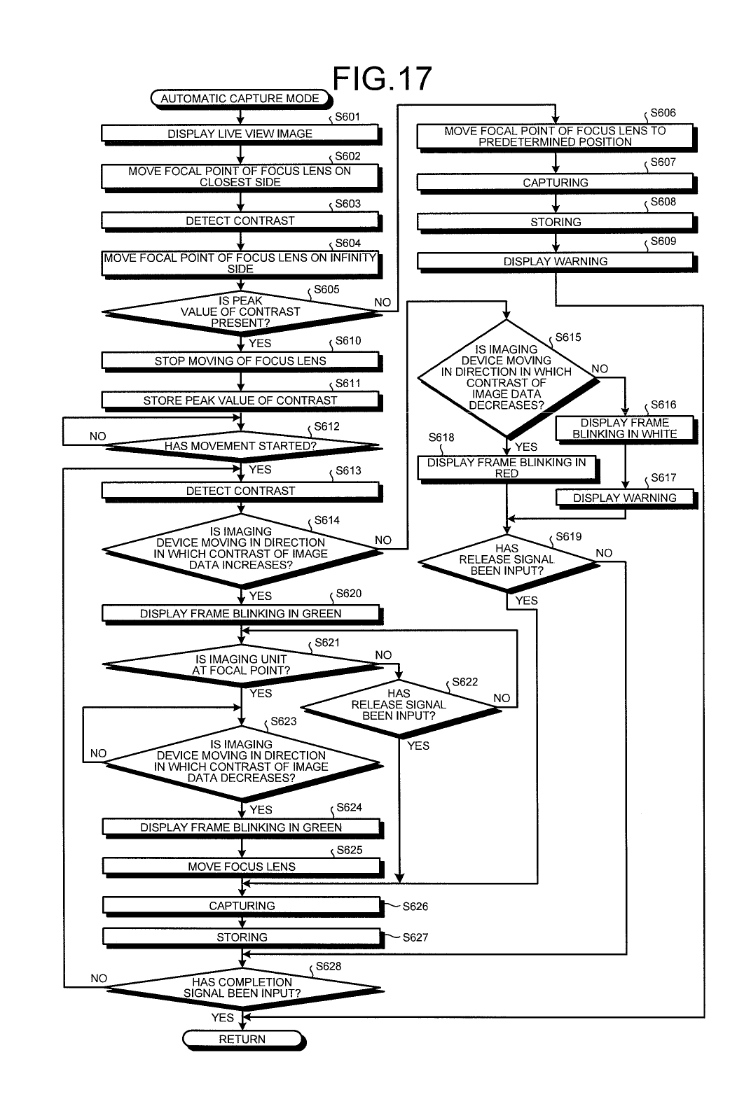

FIG. 17 is a flowchart illustrating, in detail, the flow of a process performed by the imaging device 1 according to the third embodiment of the present invention when it is in the automatic capture mode. In FIG. 17, the display unit 12 displays a live view image corresponding to the image data created by the imaging unit 2 (Step S601).

Then, the capturing controller 13a drives the lens driving unit 2e so that it moves the focal point of the focus lens on the closest side (Step S602).

Subsequently, the contrast detector 3a detects the contrast of the image data created by the imaging unit 2 (Step S603).

Then, the capturing controller 13a drives the lens driving unit 2e so that it moves the focal point of the focus lens on the infinity side (Step S604).

Subsequently, the capturing controller 13a determines whether a peak value is present in the contrast of a plurality of pieces of the image data detected by the contrast detector 3a (Step S605). If a peak value is not present in the contrast of the image data (No at Step S605), the capturing controller 13a drives the lens driving unit 2e so that it moves the focus lens to a predetermined position, for example, to a focal point of a default setting (Step S606).

Then, under the control of the capturing controller 13a, the imaging device 1 captures an image to record image data (Step S607) and allows the removable memory 11 to store the image data that is created by the imaging unit 2 and that is subjected to image processing by the image processing unit 3 (Step S608).

Subsequently, the display unit 12 displays an alarm display indicating that a peak value of the contrast of the image data cannot be detected (Step S609), and the imaging device returns to the main routine.

In contrast, if a peak value is present in the contrast of the plurality of pieces of the image data detected by the contrast detector 3a (Yes at Step S605), the capturing controller 13a stops the driving of the lens driving unit 2e and stops the moving of the focus lens (Step S610).

Then, the contrast storage unit 10a stores therein, in an associated manner, the peak value of the contrast of the image data detected by the contrast detector 3a and the focal point of the focus lens on the optical axis of the imaging unit 2 (Step S611).

Subsequently, the capturing controller 13a determines whether the imaging device 1 starts moving (Step S612). If the imaging device 1 has not started moving (No at Step S612), the capturing controller 13a repeats this determination. In contrast, if the imaging device 1 starts moving (Yes at Step S612), the imaging device 1 proceeds to Step S613.

Then, the contrast detector 3a detects the contrast of the image data created by the imaging unit 2 (Step S613).

Subsequently, in accordance with the difference between the peak value of the contrast of the image data stored in the contrast storage unit 10a and the contrast of the image data detected by the contrast detector 3a, the focus determining unit 5 determines whether the imaging device 1 is moving in the direction in which the contrast of the image data increases (Step S614). If the imaging device 1 is not moving in the direction in which the contrast of the image data increases (No at Step S614), the imaging device 1 proceeds to Step S615.

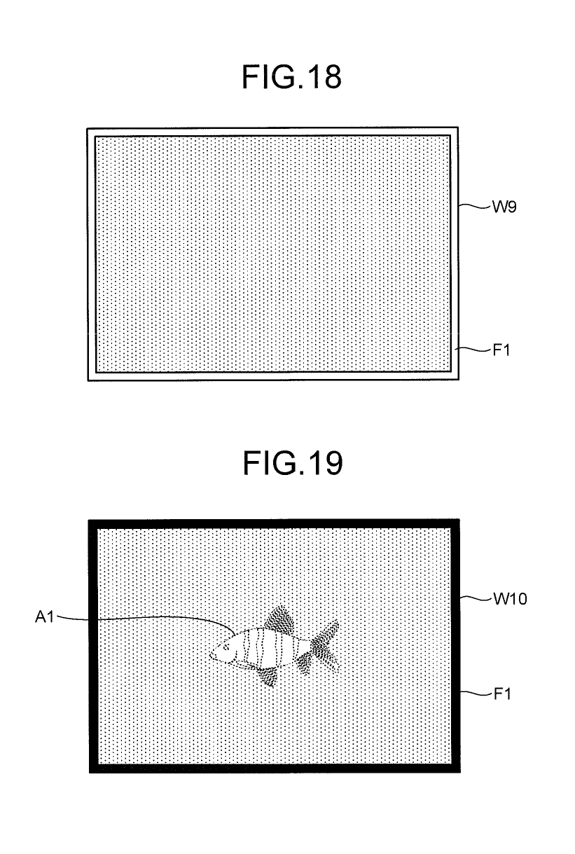

Then, in accordance with the difference between the peak value of the contrast of the image data stored in the contrast storage unit 10a and the contrast of the image data detected by the contrast detector 3a, the focus determining unit 5 determines whether the imaging device 1 is moving in the direction in which the contrast of the image data decreases (Step S615). If the imaging device 1 is not moving in the direction in which the contrast of the image data decreases (No at Step S615), the display controller 13b displays, on the display unit 12, a blinking white frame, for example, displays a display screen W9 illustrated in FIG. 18 and displays a frame F1, which is arranged on the outer circumferential edge of the display screen W9, blinking in white (Step S616). Then, the display unit 12 displays a text alarm display indicating, for example, that the subject A1 cannot be captured (Step S617) and then the imaging device 1 proceeds to Step S619.

In contrast, if the imaging device 1 moves in the direction in which the contrast of the image data decreases (Yes at Step S615), the display controller 13b displays, on the display unit 12, a blinking red frame, for example, displays the frame F1, arranged on the display screen W10 as illustrated in FIG. 19, blinking in red (Step S618).

Then, the capturing controller 13a determines whether a release signal has been input by an operation of the release switch 8a (Step S619). If the release signal has not been input (No at Step S619), the capturing controller 13a proceeds to Step S628. In contrast, if the release signal has been input (Yes at Step S619), the imaging device 1 proceeds to Step S626.

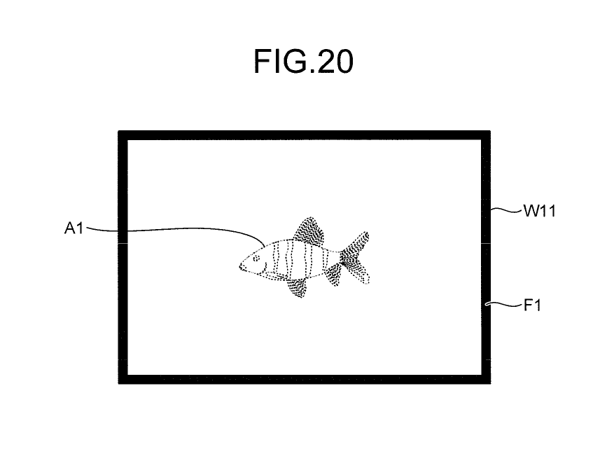

In contrast, in accordance with the difference between the peak value of the contrast of the image data stored in the contrast storage unit 10a and the contrast of the image data detected by the contrast detector 3a, the focus determining unit 5 determines that the imaging device 1 moves in the direction in which the contrast of the image data increases (Yes at Step S614), the display controller 13b displays, on the display unit 12, a blinking green frame, for example, displays a frame F1, arranged on the display screen W11 as illustrated in FIG. 20, blinking in green (Step S620).

Then, in accordance with the contrast of the image data detected by the contrast detector 3a, the focus determining unit 5 determines whether the imaging unit 2 is at a focal point (Step S621). If the imaging unit 2 is not at the focal point (No at Step S621), the capturing controller 13a determines whether a release signal has been input by an operation of the release switch 8a (Step S622). If the release signal has not been input (No at Step S622), the imaging device 1 proceeds to Step S621. In contrast, if the release signal has been input (Yes at Step S622), the imaging device 1 proceeds to Step S626.

In contrast, if the focus determining unit 5 determines that the imaging unit 2 is at the focal point (Yes at Step S621), the imaging device 1 proceeds to Step S623.

Thereafter, in accordance with the difference between the peak value of the contrast of the image data stored in the contrast storage unit 10a and the contrast of the image data detected by the contrast detector 3a, the focus determining unit 5 determines whether the imaging device 1 is moving in the direction in which the contrast of the image data decreases (Step S623). If the imaging device 1 is not moving in the direction in which the contrast of the image data decreases (No at Step S623), the imaging device 1 repeats this process. In contrast, if the imaging device 1 is moving in the direction in which the contrast of the image data decreases (Yes at Step S623), the imaging device 1 proceeds to Step S624.

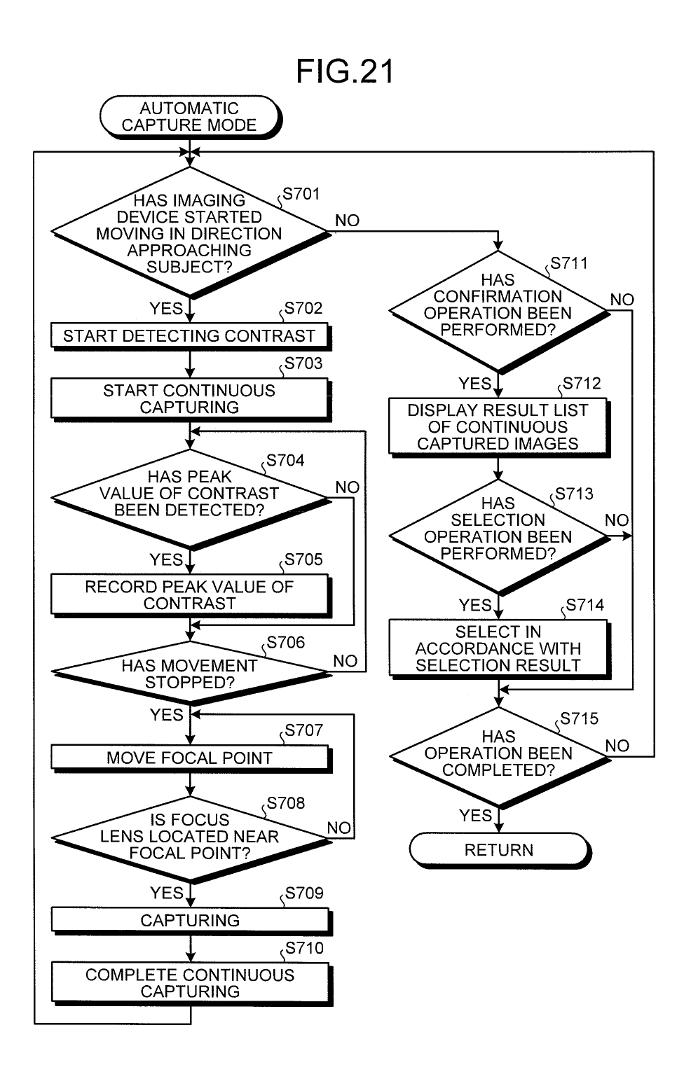

Then, the display controller 13b displays, on the display unit 12, a blinking green frame, for example, displays the frame F1 arranged on the display screen W11 illustrated in FIG. 21 blinking in green (Step S624).

Subsequently, the capturing controller 13a drives the lens driving unit 2e so that it moves the focus lens to a focal point that corresponds to the focal point of the imaging unit 2 on the optical axis (Step S625). The imaging device 1 performs, under the control of the capturing controller 13a, the capturing so that the image data is recorded (Step S626).

Then, the capturing controller 13a allows the removable memory 11 to store the image data of the image that is created by the imaging unit 2 and that is subjected to image processing by the image processing unit 3 (Step S627).

Subsequently, the capturing controller 13a determines whether a completion signal indicating the completion of the capturing has been input (Step S628). If the completion signal has not been input (No at Step S629), the imaging device 1 proceeds to Step S613. In contrast, if the completion signal has been input (Yes at Step S628), the imaging device 1 returns to the main routine.

According to the third embodiment of the present invention, in accordance with both the contrast of the image data detected by the contrast detector 3a and the peak value of the image data that is created by the imaging unit 2 and is stored in the contrast storage unit 10a, the focus determining unit 5 determines whether the imaging unit 2 is at a focal point. If the result determined by the focus determining unit 5 is that the imaging unit 2 is at the focal point, the capturing controller 13a controls the recording of the image data. Accordingly, even if the capturing is performed under water where visibility is poor or a capturing operation is awkward, it is possible to easily perform the capturing and to reliably obtain the image data of the subject A1. Furthermore, a photographer can obtain in-focus image data after setting, by moving the focus lens of the optical system 2a, the distance to the target focal point of the imaging unit 2 and then by simply bringing the imaging device 1 closer to or farther away from the subject A1.

Furthermore, according to the third embodiment of the present invention, in accordance with the difference between the peak value of the contrast of the image data stored in the contrast storage unit 10a and the contrast of the image data detected by the contrast detector 3a, the display controller 13b displays, on the display unit 12 by changing display modes, the image corresponding to the image data to be displayed. Accordingly, a photographer can easily confirm a focal point with respect to the subject and prevent camera shake.

Furthermore, according to the third embodiment of the present invention, in accordance with the difference between the peak value of the contrast of the image data stored in the contrast storage unit 10a and the contrast of the image data detected by the contrast detector 3a, the display controller 13b displays, on the display unit 12 by changing display modes, the image corresponding to the image data to be displayed; however, the configuration is not limited thereto. For example, by arranging a small motor or a sound generator, it is also possible to annunciate, using a vibration or a sound, a focal point of the imaging device 1 in accordance with the difference between the peak value of the contrast of the image data stored in the contrast storage unit 10a and the contrast of the image data detected by the contrast detector 3a.

### Fourth Embodiment

In the following, a fourth embodiment of the present invention will be described. In the first, second, and third embodiments described above, the capturing is performed at the peak value of the contrast of the image data; however, in the fourth embodiment of the present invention, the capturing is performed when the imaging device 1 starts moving. An imaging device according to the fourth embodiment of the present invention has the same configuration as the imaging device 1 according to the first embodiment described above, except that the automatic capture mode is different from that in the first embodiment. Accordingly, in the following, only the automatic capture mode in which the imaging device 1 according to the fourth embodiment of the present invention performs will be described.

FIG. 21 is a flowchart illustrating, in detail, the flow of a process performed by the imaging device 1 according to the fourth embodiment of the present invention when it is in the automatic capture mode.

As illustrated in FIG. 21, the capturing controller 13a determines in accordance with the detection result of the movement detector 4, whether the imaging device 1 starts moving in the direction approaching a subject (Step S701). Specifically, the capturing controller 13a determines, in accordance with the detection result of the movement detector 4, whether the imaging device 1 starts moving or whether the imaging device 1 is stationary. If the imaging device 1 starts moving in the direction approaching the subject (Yes at Step S701), the imaging device 1 proceeds to Step S702, which will be described later. In contrast, if the imaging device 1 has not started moving in the direction approaching the subject (No at Step S701), the imaging device 1 proceeds to Step S711, which will be described later.

A case in which the imaging device 1 starts, at Step S701, moving in the direction approaching the subject will be described (Yes at Step S701). In such a case, the contrast detector 3a starts detecting the contrast of the image data created by the imaging unit 2 (Step S702).

Subsequently, the imaging device 1 starts, under the control of the capturing controller 13a, the continuous capturing in which image data continuously and chronologically created by the imaging unit 2 is sequentially recorded (Step S703).

Then, the capturing controller 13a determines whether the peak value of the contrast is present in the contrast of a plurality of pieces of image data detected by the contrast detector 3a (Step S704). If a peak value of the contrast is present in the plurality of pieces of image data (Yes at Step S704), the imaging device 1 allows the contrast storage unit 10a to store the peak value of the contrast detected by the contrast detector 3a (Step S705), the imaging device 1 proceeds to Step S706. In contrast, if a peak value of the contrast is not present in the plurality of pieces of image data (No at Step S704), the imaging device 1 proceeds to Step S706.

Subsequently, the capturing controller 13a determines, in accordance with the detection result of the movement detector 4, whether the imaging device 1 has stopped moving (Step S706). If the imaging device 1 has not stopped moving (No at Step S706), the imaging device 1 returns to Step S704. In contrast, if the imaging device 1 has stopped moving (Yes at Step S706), the imaging device 1 proceeds to Step S707.

After the imaging device 1 stops, the capturing controller 13a drives the lens driving unit 2e, by which the peak value of the contrast can be obtained, moves the focus lens in the optical system 2a to move a focal point of the imaging unit 2 (Step S707), and determines whether the focus lens is located near a focal point that can obtain the peak value of the contrast (Step S708). If the focus lens is not located near the focal point that can obtain the peak value of the contrast (No at Step S708), the imaging device 1 returns to Step S707. In contrast, if the focus lens is located near the focal point that can obtain the peak value of the contrast (Yes at Step S708), the imaging device 1 performs, under the control of the capturing controller 13a, the last capturing in a series of capturing (Step S709), completes the continuous capturing (Step S710), and returns to Step S701.

A case in which the imaging device 1 has not started, at Step S701, moving in the direction approaching the subject (No at Step S701) will be described. In such a case, if a command signal that is used to display, on the display unit 12, a list of the results of the image data continuously captured by the operation input unit 8 has been input (Yes at Step S711), the display controller 13b displays, on the display unit 12, the list of the results of the image data continuously captured (Step S712).

Subsequently, if a selection operation of the image data is performed by the operation of the operation input unit 8 (Yes at Step S713), the control unit 13 selects, from the list of the results on the image data, edits the image data, and records it (Step S714).

Then, if a completion command signal for a preview image has been input by the operation input unit 8 (Yes at Step S715), the imaging device 1 returns to the main routine in FIG. 8. In contrast, if the completion command signal has not been input (No at Step S715), the imaging device 1 returns to Step S701.

If the command signal that is used to display, on the display unit 12 by the display controller 13b at Step S711, the list of the result of the image data continuously captured by the operation input unit 8 has not been input (No at Step S711), the imaging device 1 proceeds to Step S715.

If the selection operation of the image data is not performed, at Step S713, by an operation of the operation input unit 8 (No at Step S713), the imaging device 1 proceeds to Step S715.

According to the fourth embodiment of the present invention described above, if the movement detector 4 detects the movement of the imaging device 1, the capturing controller 13a controls the recording of the image data. As a result, it is possible to capture, without performing a complicated capturing operation, an image simply by moving the imaging device 1 toward a desired subject.

Furthermore, according to the fourth embodiment of the present invention, if the movement detector 4 detects the movement of the imaging device 1, the capturing controller 13a controls the continuous recording of the image data. Accordingly, it is possible to reliably capture the subject and avoid missing a good photo opportunity.

Furthermore, according to the fourth embodiment of the present invention, the focus lens in the optical system 2a is made to move by driving the lens driving unit 2e so as to obtain the peak value of the contrast in accordance with the peak value of the contrast of the image data detected by the contrast detector 3a. Accordingly, it is possible to reliably obtain in-focus image data with respect to the subject.

Furthermore, in the fourth embodiment of the present invention, the capturing controller 13a can also control, in accordance with the speed that the imaging device 1 moves, the recording of the image data. For example, if the movement speed of the imaging device 1 exceeds a threshold set in advance, it is also possible to control the recording of the image data. Furthermore, if the movement speed of the imaging device 1 exceeds a threshold set in advance, it is also possible to end the control of the recording of the image data.

Furthermore, in the fourth embodiment of the present invention, the capturing controller 13a can also control, in accordance with the distance moved by the imaging device 1, the stopping of the recording of the image data.

### Another Embodiment

According to the first to fourth embodiments of the present invention, the movement detector 4 calculates the distance moved by the imaging device 1 using the acceleration sensors 41; however, the configuration is not limited thereto. For example, the distance moved by the imaging device 1 can be calculated by periodically specifying, using pattern matching, an area of the subject image, such as an image (live view image) displayed by the display unit 12, and then calculated in accordance with an increase in the size of the specified area.

Furthermore, according to the first to fourth embodiments of the present invention, if the imaging device 1 captures the subject A1, the capturing is performed only once; however, the number of capturing times is not limited thereto. For example, it is possible to perform the continuous capturing of the subject A1 a predetermined number of times.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable device comprising:
an imaging unit that creates image data of a subject;
a contrast detector that detects contrast information on the image data;
a movement detector that detects movement information of the portable device; and
a control unit that controls, in accordance with the contrast information obtained when the movement information is detected, recording of the image data.

2. The portable device according to claim 1, further comprising:
a focus lens that changes a focal point of the imaging unit; and
a lens driving unit that moves the focus lens along an optical axis of the imaging unit, wherein
the control unit drives, in accordance with the relation between the movement information and the contrast information, the lens driving unit in such a manner that the imaging unit is brought into focus and moves the focus lens.

3. The portable device according to claim 2, wherein the control unit drives, when movement of the portable device is stopped, the lens driving unit so as to obtain a focal point, which corresponds to a peak value of the contrast information obtained at the time of the movement of the portable device, and moves the focus lens.

4. The portable device according to claim 1, further comprising a display unit that displays an image corresponding to the image data, wherein
the control unit changes, in accordance with the movement information and the contrast information, a display mode of the image displayed by the display unit.

5. The portable device according to claim 4, wherein
the contrast information is contrast that is obtained for each scanning position of focal scanning, and
the control unit detects a peak value of the contrast information and changes, in accordance with the peak value and the movement information, the display mode of the image displayed by the display unit.

6. A portable device comprising:
an imaging unit that creates image data of a subject;
a movement detector that detects movement of the portable device; and
a control unit that controls, when the movement detector detects the movement, recording of the image data.

7. The portable device according to claim 6, wherein a direction of the movement is a direction approaching the subject.

8. The portable device according to claim 7, further comprising a contrast detector that detects contrast information of the image data, wherein
the imaging unit continuously creates the image data, and
the control unit controls, in accordance with the contrast information, selecting of the image data and recording of the image data.

9. The portable device according to claim 8, wherein
the contrast information is contrast obtained for each scanning position of focal scanning, and
the control unit detects a peak value of the contrast information and controls, in accordance with the peak value and the movement information, selecting of the image data and recording the image data.
